(19) United States
(12) Patent Application Publication
(10) Pub. No.: US 2011/0136077 A1
(43) Pub. Date: Jun. 9, 2011

(54) METHOD FOR MAKING A DENTAL PROSTHESIS AND RELATED SURGICAL GUIDE

(76) Inventor: Philippe Albert Paul Ghislain De Moyer, Beersel (BE)

(21) Appl. No.: 12/674,580

(22) PCT Filed: Aug. 21, 2008
(86) PCT No.: PCT/EP08/60963

§ 371 Date: Feb. 22, 2010

(30) Foreign Application Priority Data
Aug. 24, 2007 (EP) 07114952.0

(51) Int. Cl. A61C 11/00; A61C 8/00

(52) U.S. Cl. 433/173; 433/213

(57) ABSTRACT

The invention relates to a method for making dental prostheses and related surgical guides, that comprises making the prosthesis and/or the surgical guide based on a model that reproduces the bone portions of the jaw using a first material and the mucosa portions of the jaw using a second material softer than the first material, and made on the basis of a computer modelling of the mucosa portions and the bone portions of the jaw by radiographic data differentiation. The invention also relates to the individualized production in a single piece of one or more implants for such a dental prosthesis that comprises machining rods or studs of a biocompatible material. The invention further relates to a ready-to-use individualized kit for placing a dental prosthesis, that comprises this type of prosthesis, this type of surgical guide and/or one or more implants of this type, as well as screwing keys for placing the implants and optionally suitable drills.

The invention relates to the production of surgical guides (radiological guides) and of individualized dental implants, which are to be implanted in the jaw of a patient, to equipment for designing and producing such implants, and to the equipment used for such implantation.

The implants currently fitted are standard components that differ from one brand to another in terms of their shapes (cylindrical, cylindro-conical, or conical), diameters, lengths and material (titanium, zirconium oxide, etc.).

The implants are generally chosen depending on the surgical kit or kits corresponding to the brand of implants that the implantologist has chosen to place in the mouths of his patients.

The choice is also determined by the implants that the implantologist has in stock.

The stock often depends on the discount that the implant company offers according to the quantity of implants that the implantologist purchases.

It follows automatically from this that the implantologist places implants in the mouths of his patients that do not correspond to the bone structure of the patients but instead to the structure of his stock.

Within the dental sector, implantology is the specialization that has seen the strongest growth and the fastest developments in the sector.

This is also a reason for implantologists getting rid of their stock as quickly as possible.

Implants are at present implanted in four ways:

1. Freehand with a wide cut in the gum and detachment of the gum and periosteum. The implants are fitted in an archaic manner without any reference or any marker with respect to the future prosthesis. The practitioner generally takes an X-ray of the implantation site and a panoramic X-ray and sometimes sends his patient to hospital for a scan in order to have sagittal sections of the bone and to know the bone quality by virtue of computer programs. Although this technique is the worst and gives results that are often esthetically, functionally and hygienically appalling, it is the one most used. It is also the one that causes the most accidents (rupture of the nerves, rupture of blood artery, piercing of the sinus, rupture and fracture of the cortices, etc).
2. Freehand with a wide cut in the gum and a detachment of the gum and periosteum. The implants are fitted in a more or less precise manner since the dental laboratory has produced a surgical guide that to a greater or lesser extent prefigures the future prosthesis. The practitioner generally takes an X-ray of the implantation site and a panoramic X-ray and sometimes sends his patient to hospital for a scan in order to have sagittal sections of the bone and to know the bone quality by virtue of computer programs. This technique is the second most widely applied, but the disadvantage is that the surgical guide is often unusable because of the cutting of the gum, which prevents the fitting thereof. With this technique, the results are often poor at an esthetic, functional or hygienic level, and the accidents of the kind mentioned above are numerous.
3. With the hand guided by drilling guides that are produced from a computerized plan based on the information obtained by radiography (scanner, tomography, etc.). This technique makes it possible to place drilling cylinders into guides at precise points as a function of the bone or as a function of the bone and the future prosthesis. Three distinct technologies apply this method of fitting implants:
A—By means of stereolithographic guides for surgery that are produced from X-ray images (while these images may or may not contain a prosthetic guide). These stereolithographic guides are produced on the basis of the voxels contained in the radiological information. Given that the voxels are cubic, smoothing is necessary to create a stereolithographic guide, resulting in a loss of adaptation to the hard elements (teeth) and soft elements (gums). The artefacts often interfere with the production of these guides, which increases their lack of precision.
B—By means of surgical guides that are produced from an impression and a radiological guide formed on the basis of this non-compressive silicone impression (and not on the basis of an image issuing from dental radiological data). This radiological guide is then converted into a surgical guide by the insertion of guide cylinders for the drilling and the placement of the implants in the jaw. This technology is described more particularly in the publication WO 2006/082198 A.
C—By means of surgical guides that are produced from an impression and a radiological guide that is formed on the basis of this non-compressive silicone impression (and not on the basis of an image issuing from dental radiological data). This radiological guide is then converted into a surgical guide by the insertion of guide devices for the drilling and the placement of the implants in the jaw. This technology is the subject matter of patent application EP 06116963.7.

These techniques make it possible to reduce the damage to the patient, and in particular the last technique optimizes the prosthetic result.

The fourth way of fitting implants is a method as follows:

4. Freehand guided by a navigation system (GPS). This technique allows an implant to be placed more or less precisely. However, it does not prevent all damage to the patient since the drilling is still manual and slipping remains possible. In addition, it does not take account of the future prosthesis. This technique is expensive and is the one least used.

All these techniques, except 3A, 3B, 3C, have the disadvantage of having to form the final prosthesis after an impression has been taken of the jaw where the implants have been placed beforehand, which impression is taken several weeks or months after the fitting of the implants, which is complex and requires numerous post-operative interventions, which are difficult for the patient.

Moreover, most of the implants have an outer screw thread for retaining them in the bone, and an inner screw thread surmounted by an outer or inner polygon. The latter are used to fix an abutment (=the false stump of an implant designed to receive a prosthesis) straight or at an angle in the implant.

Bacteria may gather in the area of the joint between the implant and the abutment, and this may cause bone resorption peripherally at the joint between the implant and the abutment. This can be avoided by moving the limit of the joint toward the center of the implant. That is to say, the diameter of the neck of the implant is greater than the diameter of the insert of the abutment in the implant, which is referred to in dental jargon as “platform switching”.

Other implants are produced in one piece, that is to say the screw part and abutment are formed integrally.

The great advantage of this is that there is no longer a joint between the part of the implant and the abutment. The production costs are reduced by comparison with a separate implant and abutment.

The disadvantages of these implants are that the abutment part is always axial with respect to the axis of the implant and that the limit between the implant and the abutment always has a cylindrical or conical profile surmounted by a horizontal neck, which does not correspond to the gum profile.

It is also known to form dental prostheses and related surgical guides by forming the prosthesis/surgical guide on the basis of a physical model, obtained from an impression of the jaw of a patient, and of a “radiological guide” obtained by computer modeling on the basis of radiographic data and adapted to said first model, comprising parts made of radio-opaque material corresponding to the shape of the teeth intended for the prosthesis that is to be formed and to spaces between said first model and said teeth, and used to form an X-ray image thereof on the jaw of the patient.

In this context, reference is made in particular to the following documents:

WO 2007/079775 A—describing a guided surgical system (after analysis of DICOM data) with a primary tube and a secondary tube with bayonets fixed in the primary tube that guides the drill. The tube with bayonets comprises a cutting edge for cutting the gum. The implants are fitted through the primary guide.
WO 99/32045 A and WO 03/073954 A—describing a guided surgical system (after analysis of DICOM data) with a primary tube and a secondary tube fixed in the primary tube, guiding the drill. The positioning of the tubes makes it possible to drill holes in a plaster model and to fit the holes with inserts permitting production of the guide with primary guiding tubes. After the implants have been fitted, the guide and the tubes are used to record the position of the implants, using the guide to take an impression.
WO 2006/031096 A—describing a guided surgical system (after analysis of DICOM data) with a primary tube and a secondary tube fixed in the primary tube, guiding the drill. The implants are fitted by way of the primary guide. The implant comprises a separate abutment. The abutment is produced and placed in position after a second scan when the implants have become incorporated in the bone.
WO 2007/134701 A—describing a method for analyzing a bone surface by depth gauging and digitization. There is no DICOM image, only a 2D X-ray image.

The object of the present invention is to develop a method which is used for producing a dental implant to be implanted in a jaw of a patient and which overcomes the disadvantages of the prior art and allows the prosthesis to be fitted on the implant on the same day that the implant is implanted in the bone of the mouth of the patient.

To do this, the invention proposes a novel method for making a dental prosthesis and a related surgical guide, in which method the prosthesis and/or the surgical guide are formed on the basis of a first physical model, obtained from an impression of the jaw of a patient, and of a “radiological guide”, obtained by computer modeling from radiographic data and adapted to said first model, comprising parts made of radio-opaque material corresponding to the shape of the teeth intended for the prosthesis to be formed and to spaces between said first model and said teeth, and used to form an X-ray image thereof on the jaw of the patient, this novel method involving more particularly the formation of a second physical model, reproducing bone parts of the jaw in a first material and mucosa parts of the jaw in a second material less hard than the first material, on the basis of a computer modeling of the location of mucosa parts and bone parts of the jaw, by radiographic data differentiation.

In this context, the expression “physical” model is to be understood in the sense of a “material model” or “concrete model” as opposed to the computer model (essentially “non-concrete”).

According to a particular embodiment of the invention, the method entails that the second model is obtained by modifying said first model (that is to say by converting it by machining, cutting, reduction, etc.) on the basis of said computer modeling of mucosa parts and of bone parts of the jaw by radiographic data differentiation, in such a way as to reproduce bone parts of the jaw, and is covered with mucosa parts of the jaw using a relatively soft material, by molding in relation to said “radiological guide”.

According to one aspect of the invention, the method preferably comprises a step that involves virtual individualized modeling of the constituent elements (insert, abutment, etc.) of one or more implants for said dental prosthesis, as a function of said computer modeling on the basis of radiographic data, and optionally as a function of said physical model reproducing mucosa parts and bone parts of the jaw of a patient, and the individualized formation, in one piece, of each implant, by fusion of the data from the virtual modeling of their constituent elements.

This virtual individualized modeling of the constituent elements (insert and abutment) of the implants can be carried out in particular by a step involving modeling the shape of the implant on the physical model reproducing mucosa parts and bone parts of the jaw and, in a particularly suitable manner, it can involve the use of a “key” representing the position of the future teeth.

According to another preferred aspect of the invention, the novel method for making a dental prosthesis and a related surgical guide, in which the prosthesis and/or the surgical guide are formed on the basis of at least one oral impression and computer modeling on the basis of radiographic data, specifically comprises the individualized formation, in one (material) piece, of one or more implants for said dental prosthesis, by machining of rods or pegs made of biocompatible material (such as titanium, zirconia or the like), as a function of virtual pieces obtained by fusion of data from computer modeling of their constituent elements.

The novel method according to the invention can serve in a particularly suitable manner for the production of an individualized, ready-to-use “kit” for the placement of a dental prosthesis, comprising the prosthesis, a related surgical guide, one or more implants designed for the prosthesis, and one or more screwing keys for placement of the implant or implants, and, optionally, one or more drills.

The invention thus also relates specifically to a placement kit for a dental prosthesis, comprising at least one prosthesis, the related surgical guide, one or more implants designed for the prosthesis or prostheses, and one or more screwing keys for placement of the implant or implants, and, optionally, one or more drills, in which the implants are formed in one piece, on the basis of virtual pieces obtained by fusion of data from computer modeling of their constituent elements, the implants, drills and/or screwing keys being formed in an individualized manner for said prosthesis as a function of the morphology of the jaw for which the prosthesis is designed.

The invention thus relates more particularly to a placement kit that is produced according to an operating mode as described above and/or in the specific example below.

Other features and other details of the invention will become clear from the following detailed description of a particular embodiment of the invention, given by way of example, and with reference to the attached figures.

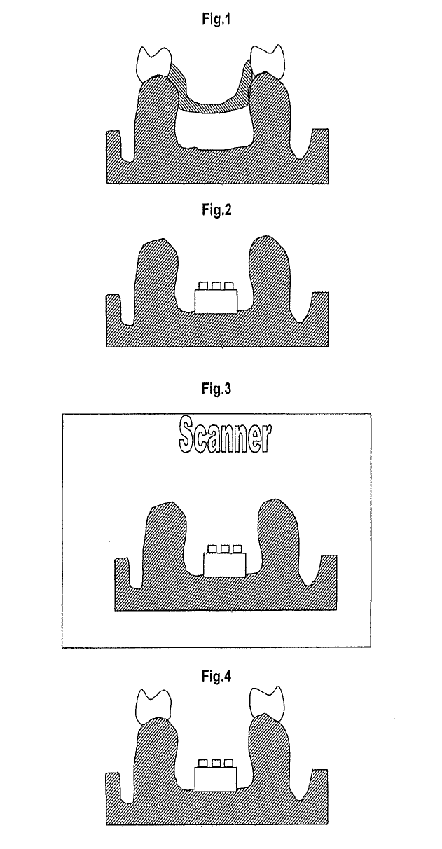

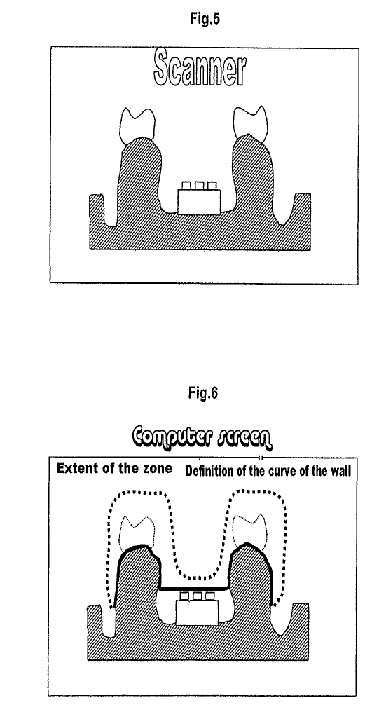

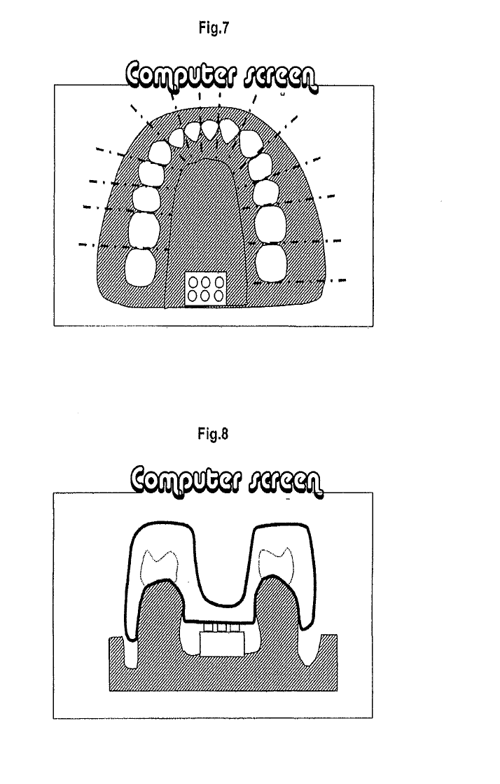

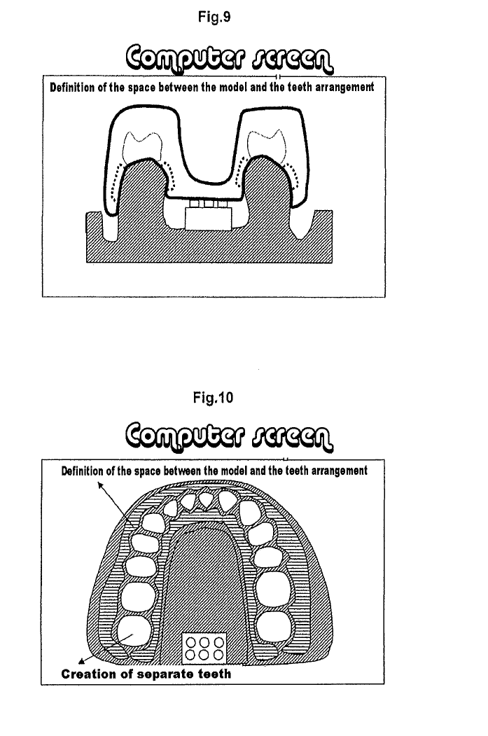

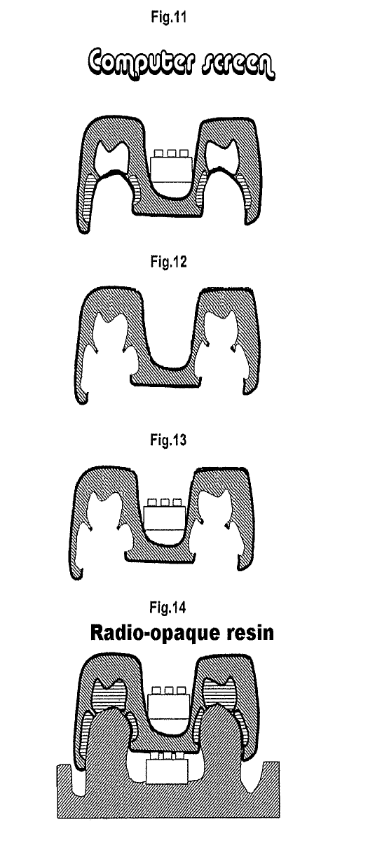

The method according to the invention for producing a dental prosthesis to be implanted in the jaw of a patient involves more particularly:
using an impression of the patient's jaw to form a model and an arrangement of teeth adjusted in the vestibular direction; this arrangement of teeth is tested out in the patient's mouth in order to validate the esthetics and the occlusion (FIG. 1);
after the test, a reference (for example a Lego® block) is fixed on the model of the arrangement (FIG. 2);
this model is then scanned (FIG. 3);
after the model has been scanned, the arrangement of adjusted teeth is fixed thereon by preparing the arrangement via a key, in such a way that the arrangement is adjusted both in the vestibular direction and also in the palatal or lingual direction (FIG. 4);
the model with the reference, but surmounted by the arrangement of teeth, is then scanned again (FIG. 5);
these scanner data are then processed by computer; a correlation is made between the data of the model and the data of the model with the arrangement of teeth; on the virtual model with the arrangement of teeth, the zone on which a radiological guide will extend is defined; its limits are used to define a curvature of walls (FIG. 6);
separations are defined on the virtual arrangement (FIG. 7);
the images of the model are processed in order to define the axis of insertion and the elimination of the undercuts of the guide on the model; after this operation, the shell of the guide is produced virtually (FIG. 8);
a space is then defined on the model and around the teeth of the arrangement (FIG. 9);
this arrangement is then separated virtually in order to obtain separate teeth (FIG. 10);
this arrangement of separate teeth is then fused with the shell (FIG. 11);
these computer data are sent to a machine tool with multiple axes (multi-axis machine) or a rapid prototyping machine (3D printer, stereophotography, etc.) in order to form a guide made of resin (of polymer) in which the teeth and the spaces around the teeth are represented by voids (FIG. 12);
this guide (radiological guide) will be equipped with a suitable reference (for example another Lego® block) (FIG. 13);
the cavities of the teeth and the cavities around the teeth are then filled with radio-opaque resin (for example barium sulfate resin); the guide is positioned on the model, before hardening of the resin, and the guide is withdrawn (“demolded”) from the model after hardening of the resin (FIG. 14);
this guide will then be placed on the patient's jaw (in a hospital environment) and scanned in position;
initial computer processing of two-dimensional X-ray images (“DICOM” image”) showing the above-mentioned radiological guide in position on the jaw makes it possible to construct a three-dimensional image; in the two-dimensional and three-dimensional images, the bone part zone and the part of the soft tissues of the patient is clearly defined by virtue of the radio-opaque resin (FIG. 15).

### Formation of a 3D Model of the Bone Tissues and Soft Tissues

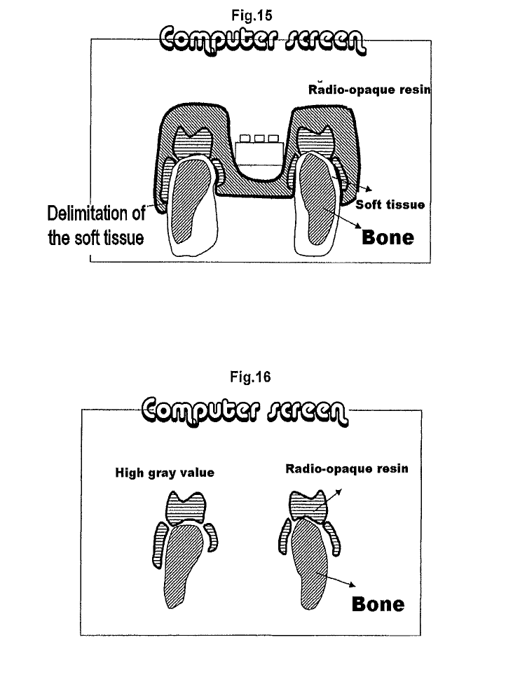

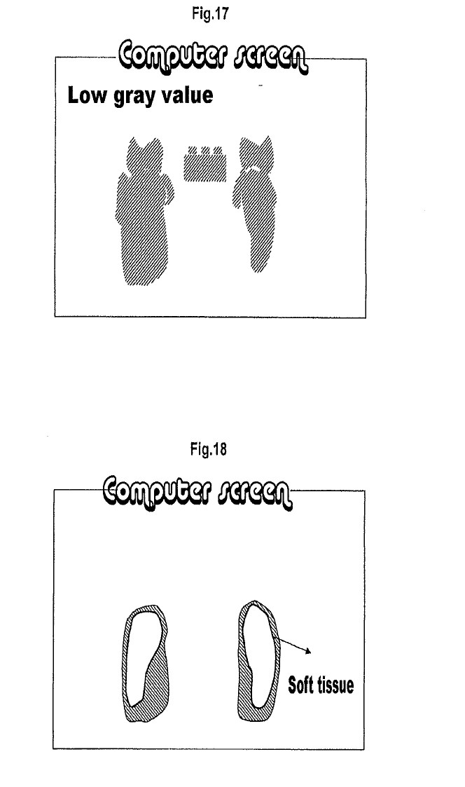

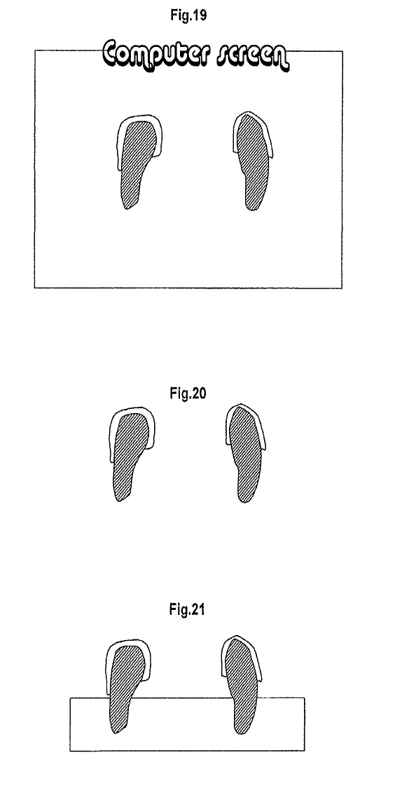

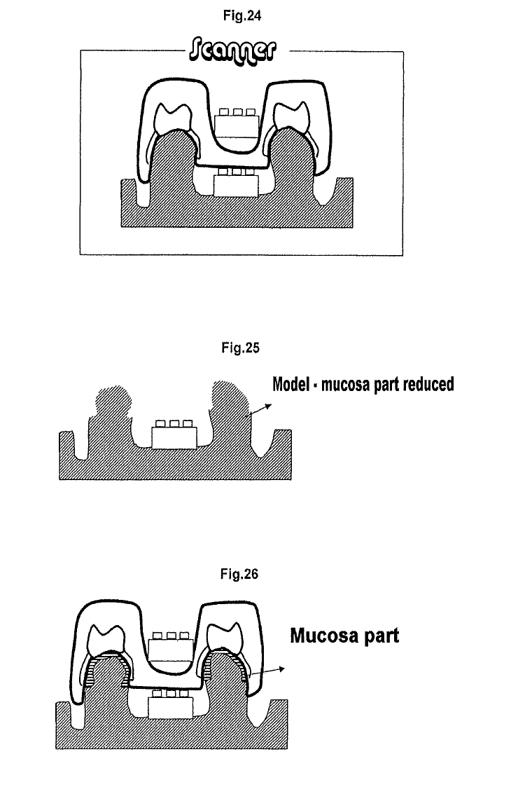

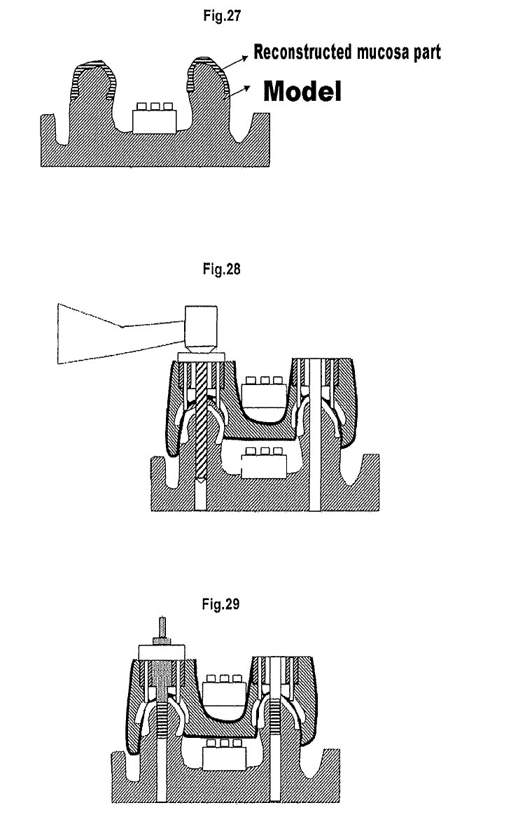

A three-dimensional model representing the bone tissues and the soft tissues (cf. FIGS. 21 and 27) is then formed using all the data (of the two-dimensional and three-dimensional images) defining the bone part and the part of the soft tissues of the patient, either by producing this model using a prototyping machine or any other machine capable of 3D reproduction of hard parts and less hard/more elastic/softer parts (according to a first operating mode explained in detail below with reference to FIGS. 16-21), or by converting the first model, formed on the basis of an impression of the patient's jaw according to the procedure described above, into a model presenting hard parts and soft parts (according to a second operating mode explained in detail below with reference to FIGS. 24-27)
first operating mode
   in the 2D and 3D images, two clearly distinct zones are defined/visualized: the bone part and the soft tissue part; these parts can be defined, for example, by different gray values (low value for soft tissues and high value for hard tissues and bone); there are specific scales for measuring the gray values; by viewing the image with a high gray value (filter), the bone part and the radio-opaque part of the guide are visualized (FIG. 16); by viewing the image with a low gray value (filter), all the parts are visualized: bone part, soft tissue part and radio-opaque part of the guide (FIG. 17); by subtracting the first image (high value) from the second image (low value), the soft tissue part is obtained (FIG. 18); these parasitic values are eliminated (e.g. gray value outside zone of the soft tissue part); then, in the first image (high value), the data of the radiological guide are cleaned; by combining and transferring files “new high value” (hard tissue part) and low value (soft tissue part) (FIG. 19), it is possible to form a model representing the bone part and the soft tissue part with a rapid prototyping machine (3D printer, stereophotography, etc.) or any other machine capable of 3D reproduction of the bone part and the mucosa part of the patient (FIG. 20); a receiving platform is then formed on the abovementioned model (FIG. 21).
second operating mode:
   the model on which an arrangement of teeth has been formed in the laboratory (FIG. 2) is used; this model, with its positioning reference, is scanned in the laboratory; the model, with the reference, and the radiological guide (FIG. 12) are then scanned together (FIG. 24); the correlation (fusion) between the data of the DICOM scanner and the data of the laboratory scanner will make it possible to modify the radiological guide to a surgical guide, thereby making it possible to define on the model the mucosal limit of the desired areas; by means of a machine tool with multiple axes, the model of the portions representing the mucosa part will be reduced; this reduction will be done in such a way that except for well defined areas the surface will remain intact (FIG. 25); the radiological guide is placed on the model thus modified and will be stabilized by virtue of the areas of the surface left intact; a “curable” material that remains soft after reaction is then injected into the “modified” (reduced) zones between the guide and the model (FIG. 26); a model is thus obtained with the same bone and mucosa data as those of the patient (FIG. 27).

### (Virtual) Positioning/Modeling of the Implants

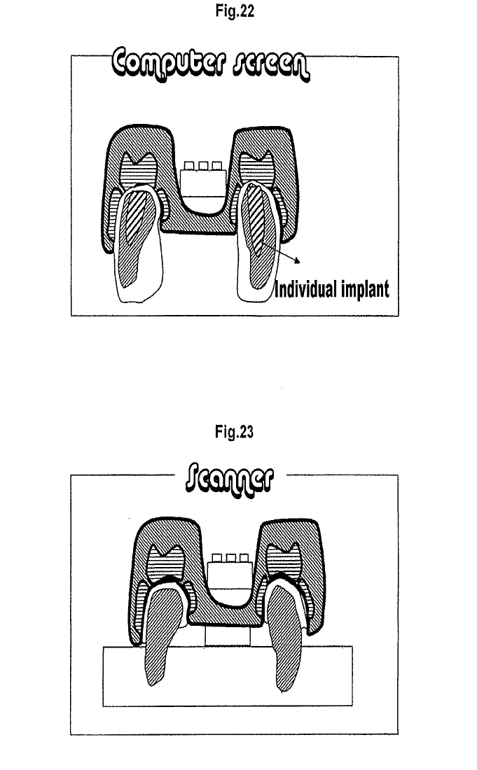

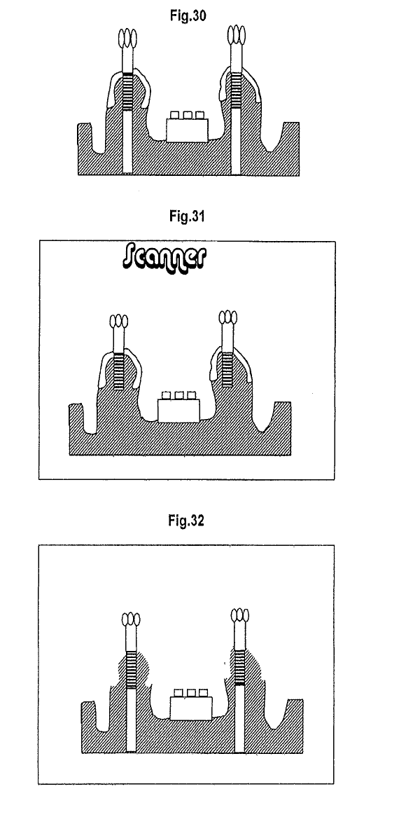

a second computer processing operation is carried out on the two-dimensional X-ray images representing the abovementioned radiological guide in position on the jaw, in such a way as to construct a three-dimensional image, in order to insert, into the two-dimensional and three-dimensional images for each tooth, a virtual implant composed (modeled) individually in a suitable surgical position in the image of the jaw, and a virtual guide device oriented coaxially to the virtual implant in the image of the radiological guide (FIG. 22); these implants can be designed from databases with existing shapes or can be configured individually for each tooth of the patient; the drill guiding systems can in particular be positioned according to one or other of the operating modes according to the aforementioned documents WO 2006/050584 and EP 06116963.7;
the radiological guide is then placed on the model obtained with its platform (according to FIG. 21 or according to FIG. 27) and provided with a reference piece (for example a Lego® block) outside of the guide zone;
the model with its reference and with the radiological guide is then scanned in the laboratory (FIG. 23).
   Converting the Radiological Guide into a Surgical Guide
on the basis of the data gathered and calculated by the computer during the steps of image processing and of insertion of implants composed individually and virtually and of virtual guide devices, the radiological guide is then converted into a surgical guide; in a first drilling operation in each artificial tooth supported by the radiological guide, a first hole is formed that is able to receive a guide device disposed and oriented like the guide device disposed and oriented according to the corresponding virtual guide device of the two-dimensional and three-dimensional images, and one such guide device provided with at least one external marker is placed in each first drilled hole;
a second drilling operation, guided through each guide device, forms a second hole through the model, using drills with the same peripheral dimensions as the final drill that will be used at the time of surgery (FIG. 28);
an implant analog is placed in each second hole by sliding into the guide device an analog holder that carries the abovementioned implant analog, as far as a depth corresponding to that of the virtual implant on the two-dimensional and three-dimensional images, and by matching, by rotation, at least a second external marker provided on the analog holder with said first external marker of the guide device;
said implant analog has a neck with dimensions corresponding to those of the virtual and individually composed implant selected for insertion in the two-dimensional and three-dimensional images and corresponds to a real implant to be placed in the jaw of the patient; said implant analog holder brings the analog in the area of the neck to the same height as the neck of the individually composed implant for the implantation of said real implant to be fitted;
the implant analog is fixed in its hole as fitted (FIG. 29);
after removal of each analog holder and of the surgical guide, a reference piece is placed on the analog (FIG. 30);
the model with its soft part and its reference, and the analog and its reference, are then scanned in order to obtain a three-dimensional spatial position of the model and of the analog (FIG. 31);
the model without its soft part and its reference, and the analog and its reference, are then scanned in order to obtain a three-dimensional spatial position of the model and of the analog (FIG. 32);
the data from the scanner are then integrated in a computer program with a positioning marker (for example a Lego® block);
the model is then withdrawn from the scanner and the reference on the analog removed.

### Modeling of Abutment(s)

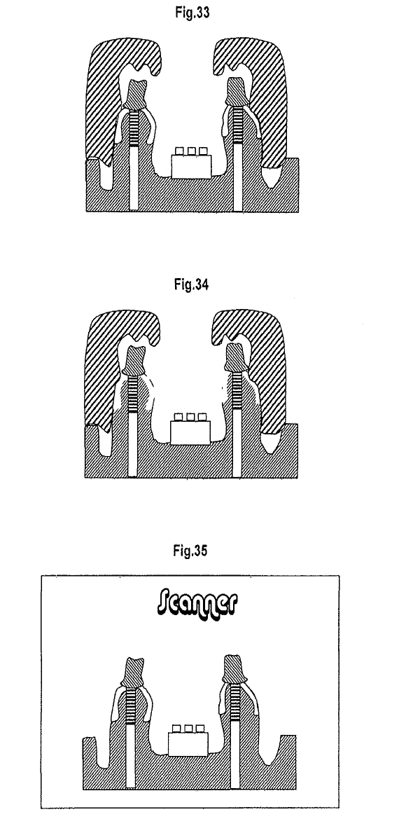

the modeling (by hand or computer) of the abutments then takes place:
in the case of modeling by hand, a work insert is fixed in the analog of the model (three-dimensional model representing the bone tissues and the soft tissues, according to FIG. 21 or 27) on which manual modeling of the abutment is carried out taking into account all the information from the planned tooth assembly (FIG. 1). The shape of the abutment is formed using a guide/marker (“key”) representing the position of the future teeth; all the supragingival parts are formed during this modeling, and the abutment is then detached, the “soft tissue” part of the model is withdrawn and the abutment is repositioned (FIG. 34); the finishing of the abutment is completed by joining the supragingival emergence profile to the neck of the implant; in this operation, account is taken of the relief of the bone part represented on the model.
in the case of modeling by computer, the formation of the abutment takes account of the bone mass around the future implant by analysis of the two-dimensional and three-dimensional images of the scanned models and by viewing the 3D model which represents the bone part and mucosa part of the patient; all of the bone and gum images will make it possible to create a correct emergence profile between the base of the implant and the exit of the abutment from the gum (FIG. 35), while modeling the emerging part of the support of the prosthesis with its angulation and its shapes necessary for corresponding to the assembly pre-established (FIG. 5) with the patient.

In the case of multiple implants and abutments, it is also necessary (both in the case of modeling by hand and in the case of modeling by computer) to ensure parallelism between the abutments so as to permit insertion of the future prosthesis.

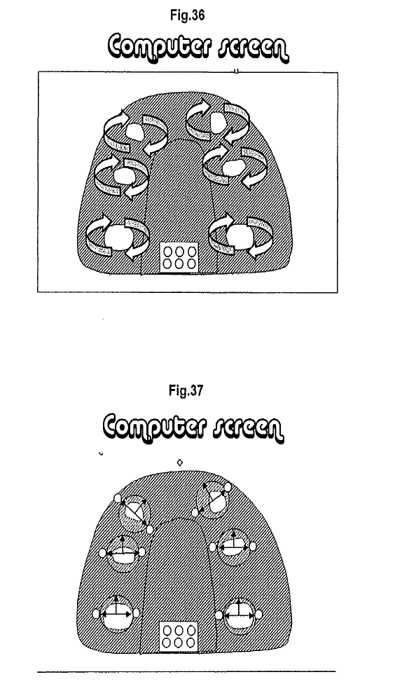

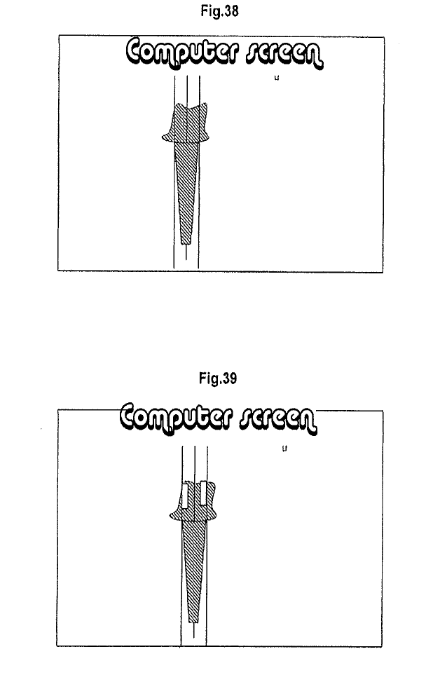

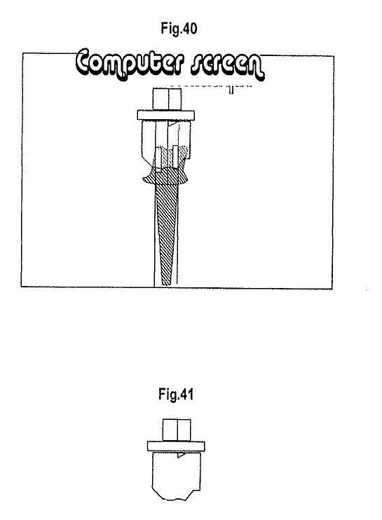

In the case of modeling by hand, the model with the reference, the analog and its abutment must be scanned again (FIG. 35).
The data from the scanner are then integrated in the computer program with a suitable positioning marker (for example a Lego® block); a simulation of rotation by computer is then executed in order to calculate the radius of rotation of the implant about its axis of screwing into the bone of the patient and thereby define the feasibility of the shape of the implant (FIG. 36); this radius must be smaller than the space between the drill guide axes; this radius must include a minimal thickness for the wall of a future screwing key; it is then possible to verify the feasibility of the shape of the abutment (FIG. 37); if the central diameter of the drilling device is less than the external diameter of the key, the latter will have to be modified, preferably in such a way as to meet the criteria of the techniques according to the above-mentioned documents WO 2006/050584 and EP 06116963.7;
by virtue of the computer program, it is possible to fuse the data of each virtual implant with those of each abutment and from these produce a single virtual piece (FIG. 38);
these data are then transferred to a machining center which, by virtue of machine tools, can form an implant and abutments in a single piece from titanium, zirconia, etc;
in parallel, and on the basis of the scanned abutments, the laboratory produces a temporary or final prosthesis (independently of the formation of the implant, and before placement of the implant).

### Formation of the Real Implant

in the machining center, the individual implants will be formed as rods or pegs made of biocompatible materials such as titanium, zirconia, etc. (FIG. 39);
the data of the head (abutment) of each implant allow the machining center to create a male key matching the axis of the implant by integrating polygons for screwing parallel to the axis of the part which is positioned within the bone; the screwing key (female key) is at this moment conceived (FIG. 40);
once the implant head has thus been modified (modeling of the male key), the machining in one piece can commence;
in parallel with the machining of the implant, a female screwing key is machined on a second machine tool; this key will fit perfectly on the abutment and the male key; on its outer part, the key will have the diameter of the drilling device and will be provided with a depth and rotation reference;
after machining of the implant and of the screwing key, the adaptation of the assembly is verified;
specific drills are made from zirconia, steel, etc.; the drills can be formed in such a way that the guidance of the drill will anticipate the drilling in a drill device according to document EP 06116963.7 mentioned above; this will result consequently in at least one or more short drills and a final drill.

### Placement Kit

on the day of surgery, a tailor-made assembly comprising surgical guide, drills, implant, keys and prosthesis will be delivered as a “prosthesis placement kit”.

The method according to the invention affords the great advantage of determining by image the position and the shape of each of the implants to be implanted in an ideal position in the jaw, as a function of the anatomical situation (position of the mandibular nerves, sinuses, etc.). By suitable guiding (for example according to document EP 06116963), it is possible, in a reproducible manner, to introduce into a model, and subsequently in the same way into the jaw, an implant analog and respectively a similar implant. This introduction is always done in such a way that the implant and the implant analog are fixed in their support (model or jaw) with the position determined on the two-dimensional and three-dimensional images; that is to say, the implant analog and the implant (preferably of the monobloc type) are positioned with the same axial orientation and at the same depth; they are situated is a precise rotational position, which will be the same in both cases.

This novel method makes it possible to control with precision the bone mass and the mucosal mass around the implant, in such a way that the abutment will be formed correctly. The subgingival zone part is not blocked on the bone part at the time of screwing into the jaw of the patient.

The great advantage of an implant in one piece is that it eliminates any joint between the implant and the abutment. The implant will be constructed virtually as a function of the bone anatomy of the patient and will therefore be better adapted to the patient. The act of producing an implant in one piece also has an impact on the time needed for producing the latter. It also eliminates the need to assemble a large number of pieces (implant, abutment and screw). This method also has the important advantage of eliminating all the stocks of implants and consequently represents considerable progress in terms of production management and management of costs.

1. A method for making a dental prosthesis and a related surgical guide, which method comprises forming the prosthesis and/or the surgical guide on the basis of a first physical model, obtained from an impression of the jaw of a patient, and of a “radiological guide”, obtained by computer modeling from radiographic data, adapted to said first model, and used to form an X-ray image thereof on the jaw of the patient, characterized in that a second physical model, reproducing bone parts of the jaw in a first material and mucosa parts of the jaw in a second material less hard than the first material, is formed on the basis of computer modeling of mucosa parts and bone parts of the jaw by radiographic data differentiation.

2. The method as claimed in claim 1, wherein said radiological guide comprises parts made of radio-opaque material corresponding to the shape of the teeth intended for the prosthesis to be formed and to spaces between said first model and said teeth.

3. The method as claimed in claim 1 or 2, wherein said second model is obtained by modifying said first model, on the basis of said computer modeling of mucosa parts and of bone parts of the jaw by radiographic data differentiation, in such a way as to reproduce bone parts of the jaw, and is covered, by molding onto said first model, modified with respect to said “radiological guide”, with a material that is less hard than that of the relatively soft first model, in such a way as to reproduce mucosa parts of the jaw.

4. The method as claimed in claim 1, further comprising a step that includes virtual individualized modeling of the constituent elements of one or more implants for said dental prosthesis, as a function of said computer modeling on the basis of radiographic data, and optionally as a function of said physical model reproducing mucosa parts and bone parts of the jaw of a patient, and the individualized formation, in one piece, of each implant, by fusion of the data from the virtual modeling of their constituent elements.

5. The method as claimed in claim 4, further comprising a modeling step on the physical model reproducing mucosa parts and bone parts of the jaw.

6. The method as claimed in claim 5, wherein the modeling of the shape of the abutment is done with the aid of a “key” representing the position of the future teeth.

7. The method as claimed in claim 4, 5, or 6, wherein it comprises the individualized formation, in one piece, of an implant for said dental prosthesis, by machining of rods or pegs made of biocompatible material, as a function of a virtual piece obtained by fusion of data from computer modeling of its constituent elements.

8. The method as claimed in claim 7, wherein it serves for the production of an individualized, ready-to-use “kit” for the placement of a dental prosthesis, comprising the prosthesis, a related surgical guide, one or more implants designed for the prosthesis, and one or more screwing keys for placement of the implant or implants, and, optionally, one or more drills.

9. (canceled)

10. (canceled)

11. A placement kit for a dental prosthesis for a jaw of an individual patient, comprising at least one dental prosthesis, at least one implant with a screw part to be screwed into a bone of the jaw of the patient, and an abutment for receiving said prosthesis, characterized in that the at least one implant is in one piece, and in that the at least one implant is individualized, that is to say it has a shape that depends on the morphology of the jaw of the individual patient.

12. A kit as claimed in claim 9, further comprising at least one screwing key for cooperating with the at least one implant in order to screw the at least one implant in order to screw the at least one implant into the bone of the jaw of the patient, and in that said at least one screwing key is individualized, that is to say it has a shape that depends on the shape of the implant.
